(19) United States
(12) Patent Application Publication
(10) Pub. No.: US 2025/0379781 A1
(43) Pub. Date: Dec. 11, 2025

(54) SYSTEMS AND METHODS FOR DISTRIBUTED NETWORK FUNCTION CONFIGURATION UPDATES IN A WIRELESS NETWORK

(71) Applicant: Verizon Patent and Licensing Inc., Basking Ridge, NJ (US)

(72) Inventors: Deepak Majjiga, Irving, TX (US); Ayman Ahmed, Plano, TX (US); Kristen Sydney Young, Mine Hill, NJ (US)

(73) Assignee: Verizon Patent and Licensing Inc., Basking Ridge, NJ (US)

(21) Appl. No.: 18/735,460

(22) Filed: Jun. 6, 2024

(51) Int. Cl. H04L 41/0803; H04L 45/00

(52) U.S. Cl. CPC H04L 41/0803; H04L 45/00

(57) ABSTRACT

A system described herein may determine, based on attributes of network functions (“NFs”) of a wireless network, a plurality of NF groups, including a particular NF group that includes a particular set of NFs. The system may receive an NF configuration update, and may determine that the NF configuration update is applicable to the particular set of NFs. The system may identify a routing path associated with the particular set of NFs, which may include a sequence of NFs of the particular set of NFs. The system may output, to a first NF of the particular set of NFs, the NF configuration update and information associated with the routing path. The first NF may identify a second NF of the particular set of NFs based on the routing path, and may output the NF configuration update to the second NF based on the routing path.

### BACKGROUND

Wireless networks provide wireless connectivity to User Equipment (“UEs”), such as mobile telephones, tablets, Internet of Things (“IoT”) devices, Machine-to-Machine (“M2M”) devices, or the like. Wireless networks may include a variety of network functions (“NFs”) that each perform particular operations that facilitate the providing of wireless connectivity. For example, one type of NF (e.g., an Access and Mobility Management Function (“AMF”) or a Mobility Management Entity (“MME”)) may perform access and/or mobility-related operations, another type of NF (e.g., a Distributed Unit (“DU”)) may perform baseband processing of wireless traffic sent to or received from a UE via a radio access network (“RAN”) of the wireless network, and so on. A wireless network operator may configure the DUs for purposes such as Quality of Service (“QoS”) management, routing, load balancing, etc.

### BRIEF DESCRIPTION OF THE DRAWINGS

FIGS. 1-6 illustrate an example of assigning configuration routing paths for NFs of a wireless network, in accordance with one or more embodiments described herein;

FIG. 7 illustrates an example of NFs propagating a configuration update based on an assigned configuration routing path, in accordance with some embodiments;

FIGS. 8A and 8B illustrate an example of NFs selectively applying configuration updates based on one or more policies, in accordance with some embodiments;

FIGS. 9 and 10A-10E illustrate examples of NFs propagating a configuration update in a distributed manner based on an assigned configuration routing path, in accordance with some embodiments;

FIG. 11 illustrates an example process for propagating a configuration update in a distributed manner based on an assigned configuration routing path, in accordance with some embodiments;

FIGS. 12 and 13 illustrate example environments in which one or more embodiments, described herein, may be implemented;

FIG. 14 illustrates an example arrangement of a RAN, in accordance with some embodiments;

FIG. 15 illustrates an example arrangement of an Open RAN (“O-RAN”) environment in which one or more embodiments, described herein, may be implemented; and

FIG. 16 illustrates example components of one or more devices, in accordance with one or more embodiments described herein.

### DETAILED DESCRIPTION OF EXAMPLE EMBODIMENTS

The following detailed description refers to the accompanying drawings. The same reference numbers in different drawings may identify the same or similar elements.

Embodiments described herein provide for the configuration of multiple (e.g., dozens, hundreds, or more) NFs, or NF instances, in a wireless network in a distributed manner. As discussed herein, the distributed (e.g., decentralized) configuration of NFs in the wireless network may avoid situations where a centralized system is responsible for propagating configuration updates to the NFs, thus providing a more robust framework for propagating configuration updates (e.g., eliminating a single point of failure). As provided for herein, NFs may also maintain policy-based configuration updates and apply such updates at a later time (e.g., when conditions are applicable to such policies, even if such conditions are not applicable when the NF receives the configuration update). Additionally, some embodiments may specify distinct groups or categories of NFs, where configuration updates may be applicable only to certain groups or categories of NFs. In some embodiments, routing or forwarding paths may be established, where such paths are used by NFs to propagate configuration changes in a distributed (e.g., decentralized) manner. The routing or forwarding paths may be established based on factors such as latency (e.g., the fastest propagation of configuration updates between various NFs), redundancy (e.g., multiple paths may include the same NF), geography (e.g., NFs that are implemented by respective sets of hardware that are geographically close to each other may be selected for a given path), etc., thus enhancing overall efficiency and performance of the network.

Examples are described herein in the context of a particular type of NF, namely a DU of a RAN of a wireless network. For example, because a RAN may include a relatively large quantity of DUs, the techniques described herein may exhibit a noticeable impact in terms of performance and robustness of the wireless network. In practice, the same or similar concepts may be implemented with respect to other types of NFs.

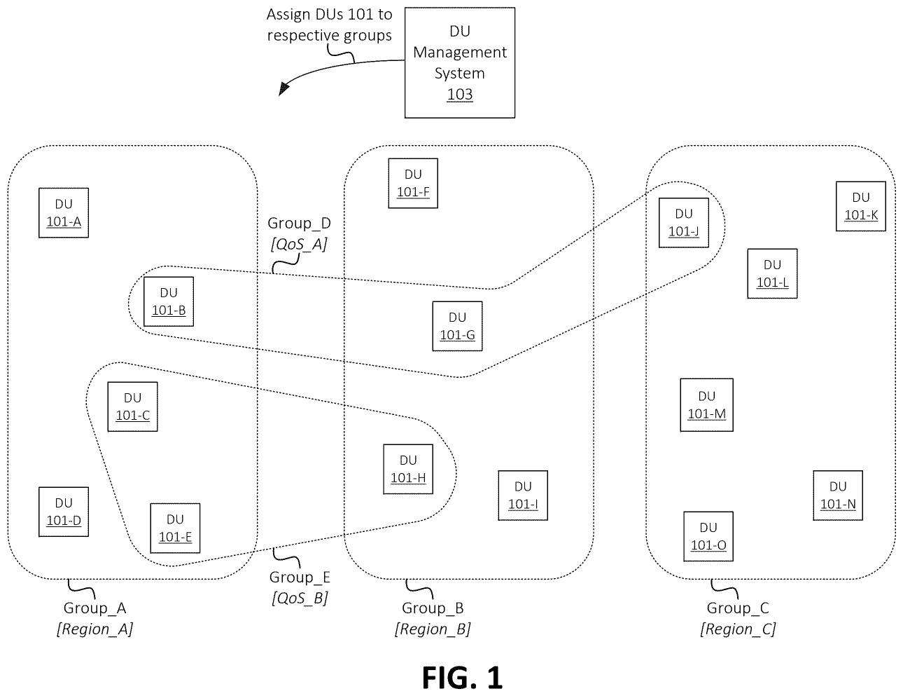

As shown in FIG. 1, a wireless network (e.g., a RAN of the wireless network) may include a relatively large quantity of DUs 101, including example DUs 101-A through 101-O. As discussed below, DUs 101 may perform particular operations with respect to the wireless network, such as performing baseband processing for traffic sent to or received from UEs (e.g., via radio units (“RUs”) that are communicatively coupled to such DUs 101). The baseband processing may include, for example, lower layer processing, such that UEs are able to send and receive wireless signals to and from a core network via DUs 101 and one or more other devices (e.g., RUs, Central Units (“CUs”), etc.).

DUs 101 may be geographically distributed (e.g., located in different cities, towns, states, provinces, regions, countries, etc.), and/or may otherwise serve UEs that are located in different geographical regions. DU Management System (“DMS”) 103 may be associated with an owner or operator of the network, and may have access to configure some or all DUs 101. For example, DMS 103 may maintain one or more keys or authentication tokens, or may otherwise implement one or more authentication mechanisms by which DUs 101 are able to verify and authenticate configuration instructions received from DMS 103. DMS 103 may also monitor or maintain information indicating attributes of each DU 101, such as location, hardware attributes (e.g., processor type or quantity, amount of memory, amount of storage space, make, model, etc.), load metrics (e.g., used or available capacity), performance metrics (e.g., latency, throughput, etc.), and/or other information regarding each DU 101. For example, DMS 103 may directly communicate with one or more DUs 101 (e.g., via an application programming interface (“API”) or other suitable communication pathway), and/or may receive such information from some other suitable device or system that is able to monitor or determine such information.

In accordance with some embodiments, DMS 103 may assign DUs 101 to respective groups based on such attributes (e.g., location, hardware attributes, performance attributes, etc.). For example, DMS 103 may assign DUs 101-A through 101-E to a first group (e.g., “Group_A”), may assign DUs 101-F though 101-I to a second group (e.g., “Group_B”), and may assign DUs 101-J through 101-O to a third group (e.g., “Group_C”). Group_A, Group_B, and Group_C may each be associated with different geographical regions with which respective DUs 101 are associated (e.g., regions in which respective DUs 101 are located, and/or regions that are served by respective DUs 101). As discussed above, DMS 103 may receive or maintain information indicating the respective regions with which each DU 101 is associated, and may assign DUs 101 to these groups based on such information.

As further shown, DMS 103 may assign respective DUs 101 to groups based on factors in addition to, or in lieu of, geographical locations associated with such DUs 101. For example, as shown, DMS 103 may assign DUs 101-B, 101-G, and 101-J to a fourth group (e.g., “Group_D”), and may assign DUs 101-C, 101-E, and 101-H to a fifth group (e.g., “Group_E”). DMS 103 may assign such groups based on attributes of such DUs 101, such as QoS attributes. For example, the DUs 101 assigned to Group_D may be associated with a first set of QoS attributes (e.g., a first network slice, a first set of performance thresholds such as minimum throughput or maximum latency, a first set of Service Level Agreements (“SLAs”), etc.), and the DUs 101 assigned to Group_E may be associated with a second set of QoS attributes (e.g., a second network slice, a second set of performance thresholds, a second set of SLAs, etc.). Thus, in some situations, the same DU 101 may belong to multiple groups.

In some embodiments, DMS 103 may assign DU groups based on a likelihood of respective configuration updates being applicable to respective sets of DUs 101. For example, DMS 103 may identify that DUs 101-A through 101-E have a relatively high measure of likelihood of being updated with the same or similar configuration updates, while other DUs 101 have a relatively lower measure of likelihood of being updated in the same or similar manner as each other. In some embodiments, DMS 103 may utilize artificial intelligence/machine learning (“AI/ML”) techniques or other suitable techniques to determine the measure of likelihood of the same or similar configuration updates being applicable to certain DUs 101. In some embodiments, the measure of likelihood may be determined based on attributes of such DUs 101, such as the example factors discussed above and/or different factors.

In some embodiments, “assigning” a given DU 101 to a given group may include DMS 103 providing information to such DU 101 that indicates that DU 101 is a member of the given group. In some embodiments, DMS 103 may provide information indicating one or more other DUs 101 that are in the same group (e.g., each DU 101 of a group may be “aware” of some or all other DUs that have been assigned to the group). For example, DMS 103 may provide an Internet Protocol (“IP”) address, a DU identifier, a device identifier, or some other suitable identifying information for such DUs 101. In some embodiments, assigning a given DU 101 to a given group may include DMS 103 maintaining information indicating that the given DU 101 is in the given group, and/or providing an indication to one or more other devices (e.g., routers, switches, etc. that are in, or that implement, a routing path between one or more DUs 101) that the given DU 101 is in the given group. In some embodiments, assigning DUs 101 to respective groups may be performed without DMS 103 indicating groups to which such DUs 101 belong. For example, in some embodiments, DUs 101 may be “unaware” of groups or categories to which such DUs 101 have been assigned, and/or may be “unaware” of one or more other DUs 101 that have been assigned to the same group.

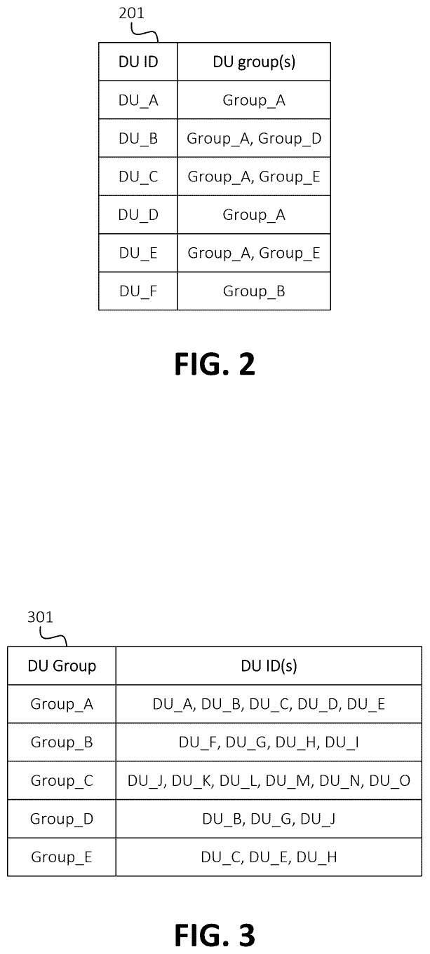

FIGS. 2 and 3 illustrate example data structures 201 and 301, respectively, that may be maintained by DMS 103 and/or one or more DUs 101. Data structure 201, in FIG. 2, illustrates an example of an indication, on a per-DU basis, of which group (or groups) to which each DU 101 has been assigned. For example, data structure 201 may include an identifier of DU 101-1, such as an IP address, DU identifier, etc. (denoted as “DU_A”), and an identifier of Group_A to which DU 101-1 has been assigned. Similarly, data structure 201 may include an identifier of one or more other DUs 101 (e.g., denoted as “DU_B, “DU_C,” etc.), as well as identifiers of respective groups to which DUs 101 have been assigned. Data structure 301, in FIG. 3, illustrates an example of an indication, on a per-group basis, of which DUs 101 have been assigned to each group. For example, data structure 301 may include an identifier of the first group (e.g., denoted as “Group_A”), as well as identifiers of DUs that have been assigned to the first group, an identifier of the second group (e.g., denoted as “Group_B”), as well as identifiers of DUs that have been assigned to the second group, and so on.

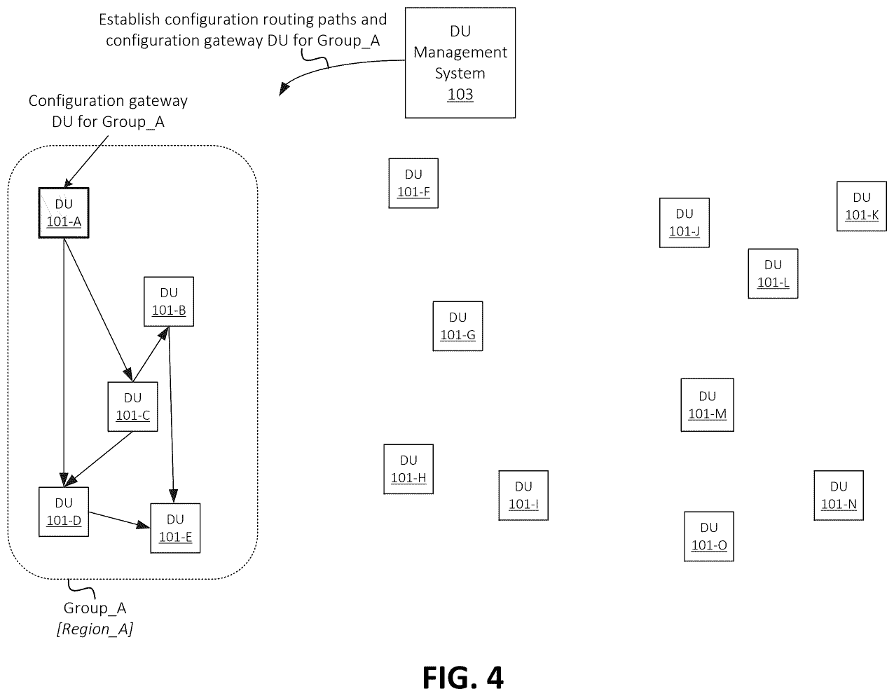

As noted above, and as shown in FIGS. 4-6, DMS 103 may establish routing and/or forwarding paths for propagating configuration updates (referred to herein as “configuration routing paths”). Configuration routing paths may refer to specific paths, hops, etc. that should be used by DUs 101 to propagate configuration changes initially provided by DMS 103 or some other authorized source. In some embodiments, DMS 103 may establish a configuration routing path for each group (e.g., each group of DUs 101 that has been established by DMS 103, as discussed above with respect to FIGS. 1-3). DMS 103 may select a configuration routing path based on factors such as performance (e.g., minimizing the amount of time for configuration updates to be routed to some or all DUs 101 of a given group), load balancing (e.g., avoiding overloading one or more DUs 101), redundancy (e.g., potentially setting a given DU 101 to receive configuration updates from multiple DUs 101), reliability (e.g., one or more DUs 101 may be associated with a measure of reliability or availability which indicates a likelihood that such DUs 101 will be operational, available, etc. at a given time), and/or other suitable factors.

In some embodiments, DMS 103 may select a configuration gateway DU for each group, which may be a particular DU 101 that serves as an entry point for configuration updates provided to the group. In some embodiments, DMS 103 may select the configuration gateway DU based on factors such as performance (e.g., based on latency between DMS 103 and a potential gateway DU), reliability (e.g., a measure of reliability, uptime, etc. of the potential gateway DU), geographical location (e.g., based on a distance between hardware that implements DMS 103 and hardware that implements the potential gateway DU), and/or other suitable factors. In some embodiments, DUs 101 may be pre-configured with routing paths or may themselves determine a routing path (e.g., a “next” DU 101 to which configuration updates should be forwarded). For example, in some embodiments, DUs 101 may not receive routing path information from DMS 103.

In some embodiments, DMS 103 may forgo selecting a configuration gateway DU for one or more groups, and/or may dynamically determine one or more DUs 101 of a given group to which configuration updates should be provided by DMS 103. In some embodiments, DMS 103 may provide group identification information with configuration updates, based on which any DUs 101 receiving such updates may determine whether these updates are applicable to respective DUs 101 (e.g., a given DU 101 may determine whether a received configuration update identifies a group to which the given DU 101 belongs), and may apply such updates if applicable to such DUs 101.

In the example of FIG. 4, DMS 103 may select DU 101-A as a DU gateway for Group_A. In situations where DMS 103 has information, instructions, etc. (e.g., a configuration update) for Group_A, DMS 103 may forward such information to DU 101-A. In this example, the configuration routing path for Group_A specifies that DU 101-A should forward configuration updates to DUs 101-C and 101-D. Accordingly, when receiving a configuration update from DMS 103, DU 101-A may proceed to forward such configuration update to DUs 101-C and 101-D. As further shown, DU 101-C may forward the configuration update to DUs 101-B and 101-D, and DU 101-D may forward the configuration update to DU 101-E.

For example, DU 101-D may be associated with a redundancy measure whereby DU 101-D receives configuration updates from DUs 101-A and 101-C. This redundancy measure may be useful in situations where, for example, DU 101-C becomes non-operational, a communication link between DU 101-C and DU 101-D becomes congested or non-operational, a communication link between DU 101-C and DU 101-A becomes congested or non-operational, etc. In some embodiments, when receiving multiple instances of the same configuration update (e.g., from both DU 101-A and DU 101-C), DU 101-D may forward each instance of the same configuration update (e.g., to DU 101-E). In some embodiments, DU 101-D may forgo forwarding a duplicate copy of the configuration update (e.g., may only send a particular configuration update to DU 101-E once, even if the same particular configuration update has been received from DUs 101-A and 101-C). In some embodiments, DUs 101 may maintain a maximum quantity of previously received configurations (e.g., the last ten received configurations, the last 25 received configurations, etc.), may maintain a maximum age of configurations (e.g., configurations that are no more than one day old, configurations that are no more than one week old, etc.), and/or may otherwise maintain “fresh” configurations or avoid maintaining “stale” configurations.

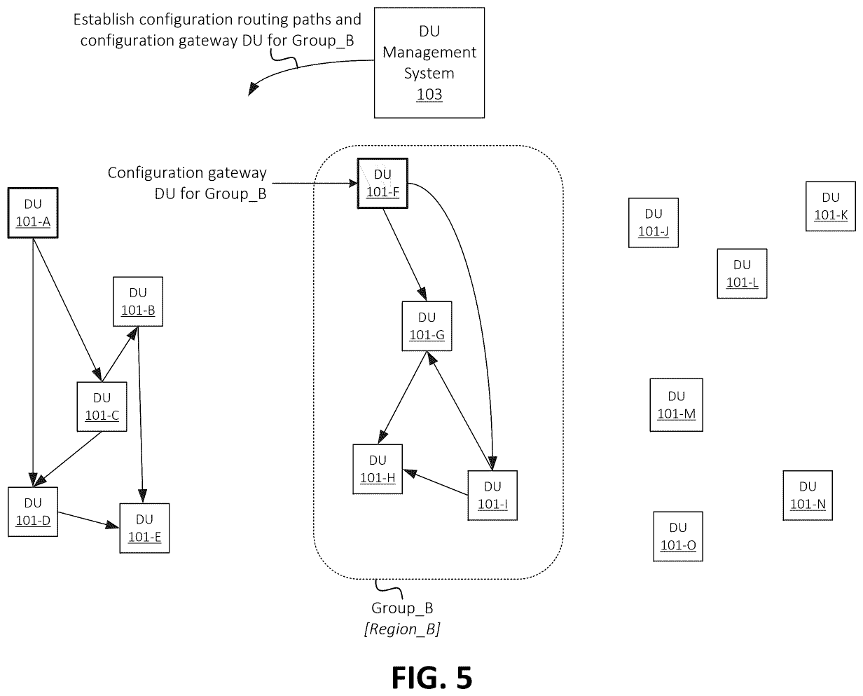

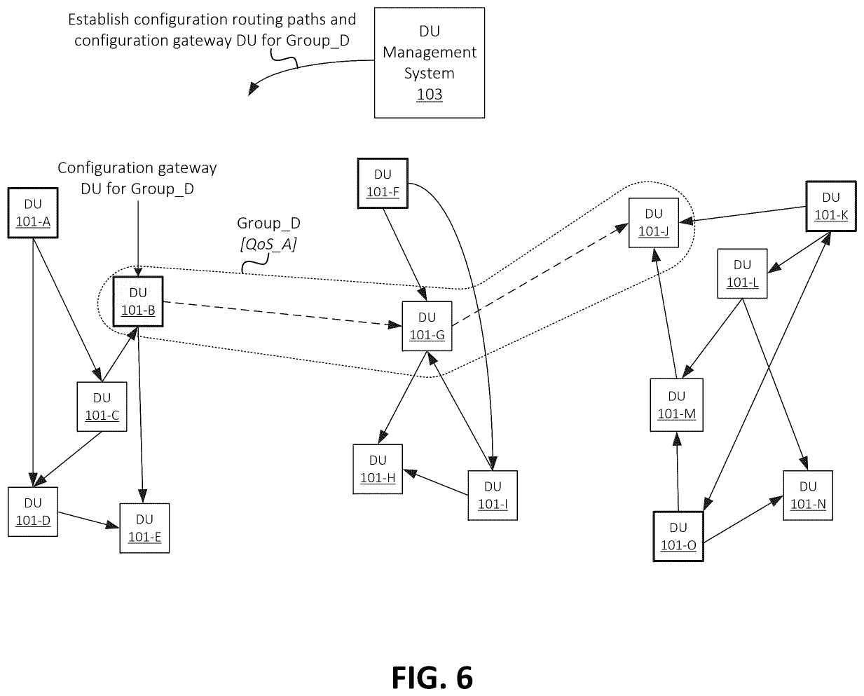

FIG. 5 similarly illustrates the designation of an example configuration routing path for Group_B, as well as the designation of DU 101-F as the configuration gateway DU for Group_B. FIG. 6 illustrates the designation of an example routing path for Group_D. As noted above, Group_D includes DUs 101 of multiple other groups. For example, DU 101-B of Group_D is also a member of Group_A (e.g., as shown in FIG. 1), DU 101-G of Group_D is also a member of Group_B, and DU 101-J of Group_D is also a member of Group_C.

As further shown, DMS 103 may designate DU 101-B as a configuration gateway DU for Group_D. That is, while DU 101-B is not the configuration gateway DU for Group_A, DU 101-B is the configuration gateway for Group_D.

In some embodiments, DMS 103 may designate multiple DUs 101 as gateway configuration DUs for a given group. For example, DMS 103 may designate DUs 101-K and 101-O as gateway configuration DUs for Group_C. Thus, in situations where DMS 103 or some other suitable device or system has a configuration update to provide to Group_C, DMS 103 may output such information to DUs 101-K and 101-O, which may proceed to forward the updates according to a routing configuration path associated with Group_C.

As noted above, in some embodiments, DUs 101 may be “aware” of one or more groups to which they have been assigned, such as by receiving such information from DMS 103. For example, DU 101-A may maintain information indicating that DU 101-A is a member of Group_A. As another example, DU 101-B may maintain information indicating that DU 101-B is a member of Group_A, Group_D, or both Group_A and Group_D). In some embodiments, as noted above, DU 101-A and/or DU 101-B may not be “aware” that DUs 101-A and 101-B are members of such groups.

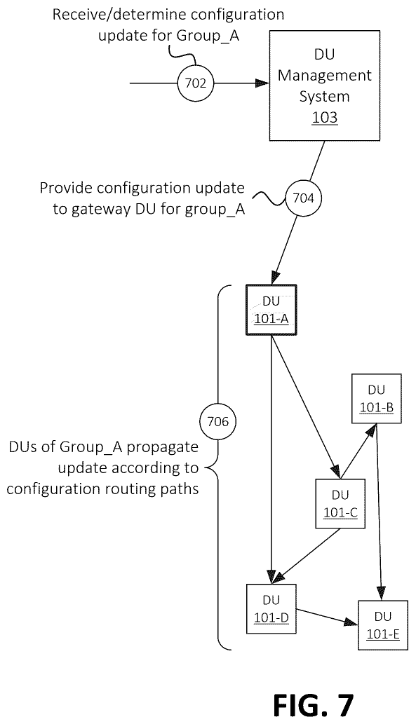

FIG. 7 illustrates an example propagation of a configuration update in a distributed manner, in accordance with some embodiments. As shown, DMS 103 may receive or determine (at 702) a configuration update for a particular group of DUs 101 (or one or more other types of NFs). For example, DMS 103 may receive such information from an administrator or operator of a wireless network with which DMS 103 is associated, or may otherwise receive or generate the configuration update based on automated techniques such as AI/ML techniques. DMS 103 may provide (at 704) the configuration update to one or more DUs 101 of Group_A, such as a gateway DU for Group_A (e.g., DU 101-A). As described in more detail below, DUs 101-A through 101-E of Group_A may propagate (at 706) the configuration update in accordance with a configuration routing path as determined by DMS 103. In some embodiments, each DU 101 of Group_A may selectively apply the configuration update, as described in more detail below.

In one example scenario, the configuration update may be applicable to one or more DUs 101 of Group_A, but may not be applicable to DUs 101 of other groups. For example, the configuration update may include parameters, values, variables, instructions, etc. that control the operation of DUs 101. The configuration update may indicate changes in QoS parameters, access parameters, queuing parameters, routing parameters, or other parameters to be implemented by some or all DUs 101 of Group_A.

The configuration update may, in some embodiments, include identifiers of particular DUs 101 to which the configuration update applies. For example, if the configuration update is applicable to DUs 101-C and 101-D, the configuration update may include respective identifiers of DUs 101-C and 101-D, or other information based on which DUs 101-C and 101-D are able to identify that the configuration update is applicable to DUs 101-C and 101-D, and/or based on which other DUs 101 of Group_A are able to identify that the configuration update is not applicable to such other DUs 101.

For example, in some embodiments, DUs 101 may determine that a given configuration update is applicable to such DUs 101 based on a group identifier associated with the configuration update. In some embodiments, DUs 101 may determine that a given configuration update is applicable to such DUs 101 based on a DU identifier associated with the configuration update. In some embodiments, DUs 101 may determine that a given configuration update is applicable to such DUs 101 based on a group identifier associated with the configuration update as well as a DU identifier associated with the configuration update. In some embodiments, DUs 101 may determine that a given configuration update is applicable to such DUs 101 based on information in addition to, or in lieu of, a group identifier or DU identifier included in the configuration update.

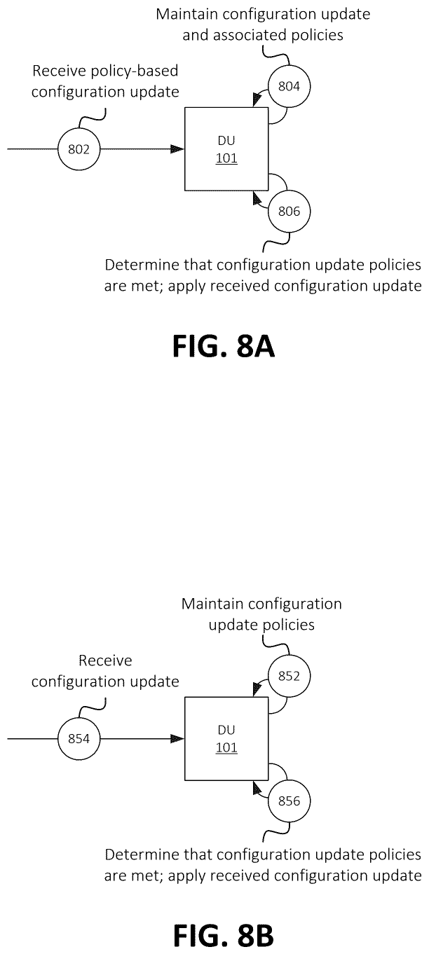

For example, as shown in FIG. 8A, a particular DU 101 may receive (at 802) a particular configuration update that includes a set of configuration update policies. Such policies may include conditions, criteria, etc. that may be evaluated by DU 101 in order to determine whether the configuration update should be applied by DU 101. For example, the configuration update policies may include criteria such as device type or attributes (e.g., a make, model, quantity or type of processors, etc. of hardware that implements DU 101), peripheral or connected device attributes (e.g., a make or model of an RU that is communicatively coupled to DU 101, frequencies or bands implemented by such RU, etc.), load thresholds (e.g., an indication that the update should be applied if DU 101 is exhibiting less than a threshold measure of load), temporal conditions (e.g., an indication that the update should be applied at certain times of day), or other suitable criteria, conditions, policies, etc.

DU 101 may maintain (at 804) the configuration update as well as the associated policies. For example, in some situations, the configuration update may not be applicable to DU 101 at the time that DU 101 receives (at 802) the configuration update. As one example, DU 101 may be exhibiting greater than a threshold measure of load indicated in the configuration update policies at the time that DU 101 receives the configuration update. In this situation, DU 101 may maintain (e.g., cache, store, etc.) the configuration update, such that the configuration update may potentially be applied at a later time. For example, at some time after DU 101 receives (at 802) the configuration update and the associated policies, DU 101 may determine (at 806) that the criteria, conditions, etc. indicated in the configuration update policies are met. For example, a measure of load associated with DU 101 may have reduced over time, and such measure of load may fall below the threshold measure of load indicated in the configuration update policy. DU 101 may accordingly apply the update based on detecting that the measure of load of DU 101 has fallen below the threshold measure of load indicated in the configuration update policy.

In some embodiments, as shown in FIG. 8B, one or more DUs 101 may maintain (at 852) a set of configuration update policies. For example, DUs 101 may be provisioned, configured, etc. by DMS 103 or some other suitable device or system, to include such configuration update policies. In some embodiments, configuration update policies maintained (e.g., (at 852) by DU 101 may be independent of or separate from configuration update policies received as part of a configuration update. For example, DU 101 may receive (at 854) a particular configuration update, which may or may not include any additional configuration update policies, criteria, conditions, etc.

As similarly noted above, situations may occur in which the configuration update is not applicable at the time that DU 101 receives (at 854) the configuration update. For example, one or more configuration update policies maintained (at 852) may not be satisfied at the time the configuration update is received. In some embodiments, DU 101 may maintain (e.g., cache, store, etc.) the configuration update (e.g., for seconds, minutes, hours, days, etc.) and may, at a later time, determine (at 856) that the configuration update policies are met. DU 101 may accordingly apply the received configuration update based on determining that such configuration update policies are met.

For example, similar to the example described above with respect to FIG. 8A, a particular configuration update policy maintained (at 852) by DU 101 may indicate that DU 101 may apply configuration update policies only when DU 101 is exhibiting less than a threshold measure of load. In an example scenario, DU 101 may receive (at 854) the configuration update while DU 101 is exhibiting greater than the threshold measure of load, and the measure of load of DU 101 may later fall below the threshold measure of load, at which time DU 101 may apply (at 856) the received configuration update.

In some embodiments, applying a given configuration update may include modifying one or more parameters, values, settings, etc. associated with DU 101. In some embodiments, applying a given configuration update may include installing an image, set of files, installation package, etc. included or indicated in a configuration update. In some embodiments, DU 101 may maintain a value representing a current configuration of DU 101 (e.g., a cryptographic hash of one or more values, variables, settings, parameters, etc.). A given configuration update may include a value representing an updated configuration (e.g., as indicated in the configuration update), such as a cryptographic hash of one or more values, variables, settings, parameters, etc. indicated in the configuration update. In some embodiments, DU 101 may compare these values (e.g., the cryptographic hash of the current configuration of DU 101 and the cryptographic hash of the configuration update) to determine whether to apply the configuration update. For example, in situations where these values match, DU 101 may forgo applying the configuration update, as a match of these values may indicate that the configuration update does not reflect any changes to the current configuration of DU 101.

In some embodiments, the policies maintained by one or more DUs 101 may be used to modify values, parameters, settings, etc. included in a configuration update. For example, one or more DUs 101 (e.g., DUs of a given group of DUs 101) may be configured (e.g., by DMS 103 or some other suitable device or system) with a set of policies that include coefficients, multipliers, modifiers, conditions, or other operations to perform on configuration updates. For example, DMS 103 may configure DUs 101 of a first geographical region, such as a rural area (e.g., DUs 101 of Group_A), to modify values of a particular type using a first coefficient, and may configure DUs 101 of a second geographical region, such as an urban area (e.g., DUs 101 of Group_B) to modify values of the same particular type using a second coefficient. In this manner, DUs 101 of different groups may receive the same configuration update, but may apply the configuration update differently. This type of policy (e.g., a configuration modification policy) may be useful to account for distinct attributes of different DUs 101 or groups of DUs 101, such as geographical region in which such DUs 101 are located, usage patterns of UEs that receive connectivity via such DUs 101, etc.

In some embodiments, when performing a configuration update, DUs 101 may maintain one or more previous configurations. In this manner, DUs 101 may be able to “roll back” changes in scenarios such as topology modification or instructions (e.g., from DMS 103) to implement a previous configuration.

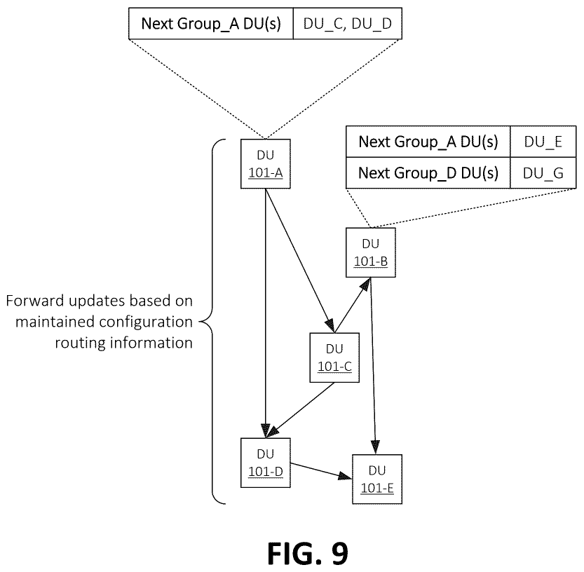

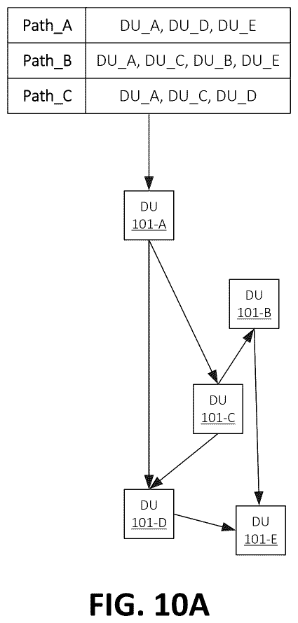

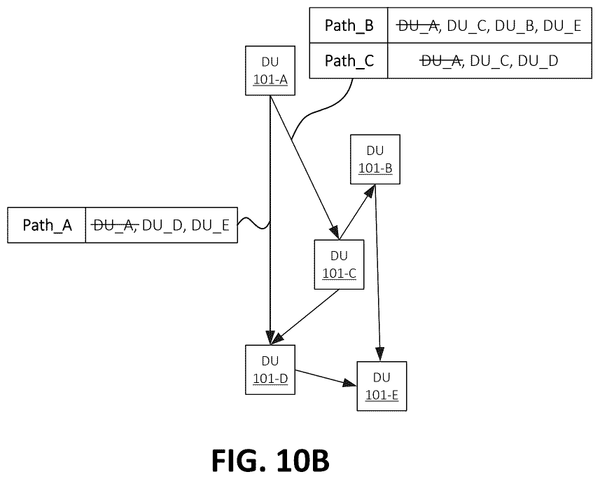

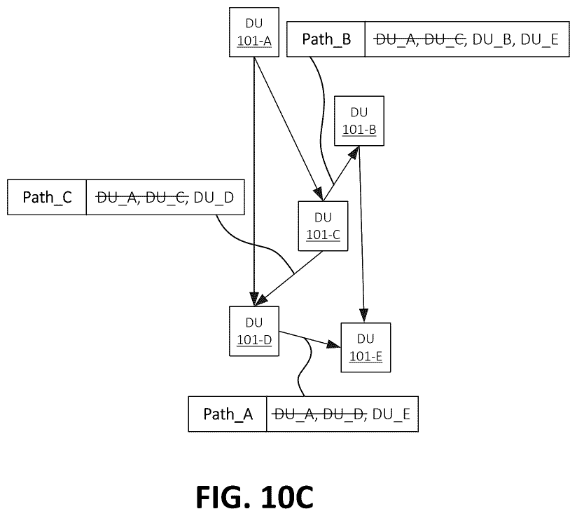

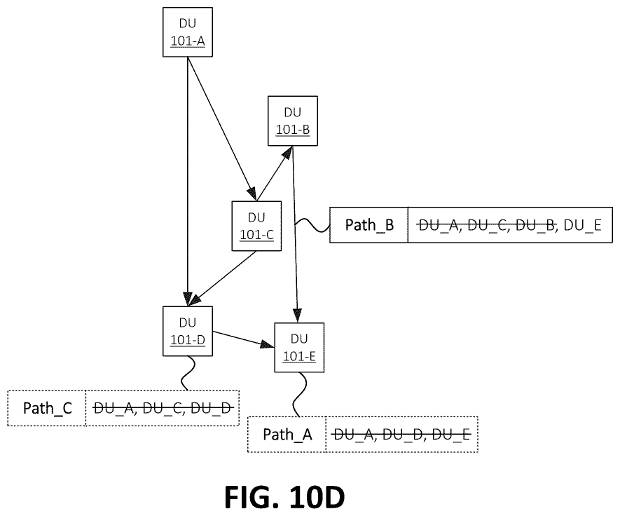

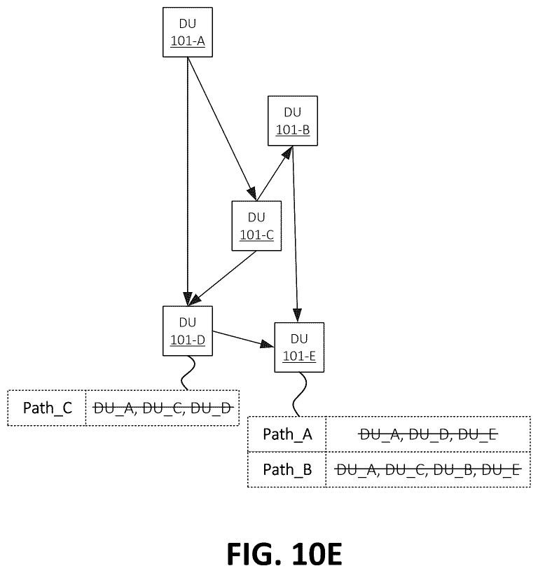

FIGS. 9 and 10A-10E illustrate further examples of how DUs 101 may forward, route, etc. configuration updates in a distributed manner, in accordance with some embodiments. As shown in FIG. 9, DUs 101 may each maintain information associating each respective DU with a given DU group, as well as DUs 101 that are immediately “downstream” in the DU group. As one example, as shown, DU 101-A may maintain information indicating that DU 101-A is a member of Group_A, and the next DUs 101 in the forwarding path of Group_A are DUs 101-C and 101-D. Thus, in some embodiments, DU 101-A may receive a configuration update that includes an indication that such configuration update is associated with Group_A. In such embodiments, DU 101-A may identify, based on the indication that the configuration update is associated with Group_A, that DU 101-A should forward the configuration update to Dus 101-C and 101-D.

As noted above, example DU 101-B may be associated with Group_A and Grouup_D. Accordingly, DU 101-B may, in some embodiments, maintain information associating DU 101-B with these multiple groups, as well as information indicating which DUs 101 are downstream of DU 101-B. Thus, in a situation where DU 101-B receives a configuration update that is associated with Group_A, DU 101-B may forward such configuration update to DU 101-E. Similarly, when DU 101-B receives a configuration that is associated with Group_D, DU 101-B may forward such configuration update to DU 101-G.

Additionally, or alternatively, as noted above, DUs 101 may not maintain or use any information associating such DUs 101 with a DU group and/or indicating which DUs 101 are next in a configuration routing path associated with such DU groups. For example, in such embodiments, DMS 103 may specify a configuration routing path when providing a configuration update. In this manner, when modifications or changes to the configuration routing path are determined by DMS 103, DMS 103 does not need to notify DUs 101 of changes to the configuration routing path.

For example, as shown in FIG. 10A, DU 101-A (e.g., a gateway DU for Group_A) may receive a configuration update (e.g., from DMS 103), along with an indication of one or more configuration routing paths for the update. In this example, three configuration routing paths are indicated (“Path_A,” “Path_B,” and “Path_C”). As discussed above, DU 101-A may apply the configuration update, cache the configuration update, determine whether the configuration update is applicable to DU 101-A (e.g., based on one or more policies maintained by DU 101-A and/or included in the update), and/or other may perform other suitable operations.

DU 101-A may further identify that the configuration update should be forwarded to DUs 101-C and 101-D. For example, example Path_A indicates that the configuration update should be forwarded by DU 101-A to DU 101-D, and Path_B and Path_C indicate that the configuration update should be forwarded by DU 101-A to DU 101-C. DU 101-A may, as shown in FIG. 10B, forward the update accordingly. In some embodiments, DU 101-A may include some or all of the configuration routing information when forwarding the configuration update. In some embodiments, DU 101-A may modify the configuration routing information prior to forwarding the configuration update. For example, DU 101-A may remove itself (and/or one or more other devices, such as a source from which the configuration update was received, such as “upstream” DUs 101) from the configuration routing paths when forwarding the configuration update. In this manner, DUs 101 that receive configuration updates in this manner may, in some embodiments, not receive routing information indicating “upstream” DUs 101 that were in the configuration routing path. For example, DU 101-D may receive information indicating that DU 101-D is in Path_A, and may also receive information indicating that DU 101-E is in Path_A. Similarly, DU 101-C may receive information indicating that DU 101-C is in Path_B and Path_C, and may also receive information indicating respective DUs 101 that are in these configuration routing paths.

As shown in FIG. 10C, DUs 101-C and 101-D may route the configuration update accordingly (e.g., in addition to applying, caching, etc. the configuration update themselves). For example, DU 101-D may forward the configuration update and routing information to DU 101-E (e.g., where such routing information omits DU 101-D, in accordance with some embodiments). Similarly, DU 101-C may forward the configuration update and routing information to DUs 101-B and 101-E (e.g., where such routing information omits DU 101-C, in accordance with some embodiments). In this manner, the size of the configuration update may be reduced at each “hop” (e.g., by virtue of removing DUs 101 from the routing path information when forwarding the configuration update). In some embodiments, the routing path information may be encrypted, and may be decrypted by each DU 101 in the routing path, thus maintaining the security of the routing information.

As shown in FIG. 10E, DU 101-E may cease forwarding the configuration update to any other DU 101, as DU 101-E is the last DU 101 in the respective configuration routing path (e.g., Path_A). Similarly, DU 101-D may cease forwarding the configuration update to any other DU 101, as DU 101-D is the last DU 101 in the respective configuration routing path (e.g., Path_C). Similarly, as shown in FIG. 10E, DU 101-E may again receive the configuration update from DU 101-B (e.g., via Path_B), but may forgo forwarding the configuration update to any other DUs 101 as DU 101-E is the last DU 101 in this particular configuration routing path.

While FIGS. 10A-10E illustrate one example set of configuration routing paths, in practice, different configuration routing paths may be implemented in accordance with some embodiments. For example, in some embodiments, a first configuration routing path may include (in sequence) DUs 101-A, 101-D, 101-C, 101-B, and 101-E. A second configuration routing path may include (in sequence) DUs 101-A, 101-C, 101-D, 101-E, and 101-B. A third configuration routing path may include (in sequence) DUs 101-A, 101-C, 101-B, 101-E, and 101-D. In such an example, all configuration routing paths may include all DUs 101 of the group, but in different sequences.

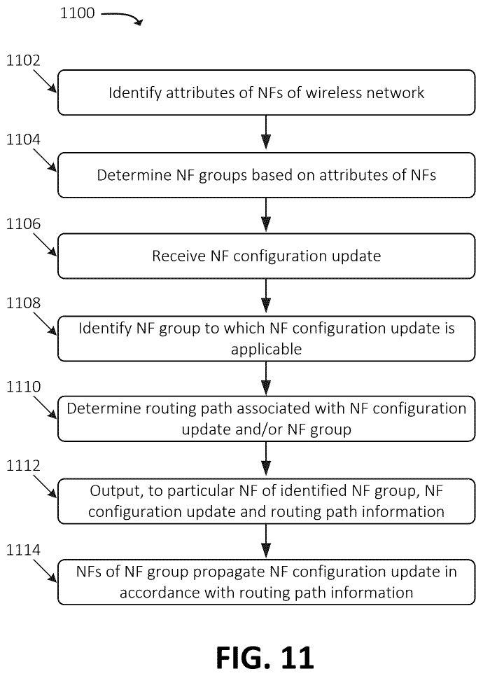

FIG. 11 illustrates an example process 1100 for propagating a configuration update in a distributed manner based on an configuration routing path (e.g., as assigned by DMS 103 and/or as automatically determined by DUs 101 and/or some other suitable device or system). In some embodiments, some or all of process 1100 may be performed by DMS 103. In some embodiments, one or more other devices may perform some or all of process 1100 in concert with, and/or in lieu of, DMS 103. As noted above, examples above were provided in the context of the configuration of DUs 101 of a wireless network. In practice, and as described with respect to FIG. 11, similar operations may be performed with respect to any suitable type of NF of a wireless network.

As shown, process 1100 may include identifying (at 1102) attributes of NFs of a wireless network. For example, as discussed above, DMS 103 may identify attributes of one or more NFs of a wireless network, such as geographical region, hardware attributes, performance metrics, load metrics, etc. The attributes may be monitored or determined on an ongoing basis, such that DMS 103 maintains up-to-date attribute information of the NFs. The NFs referred to herein may be multiple instances of the same type of NF, such as geographically distributed instances that are implemented on discrete sets of hardware resources.

Process 1100 may further include determining (at 1104) one or more NF groups based on the attributes of the NFs. For example, DMS 103 may select particular NFs (e.g., NF instances) that have the same or similar attributes, that are associated with a relatively high measure of likelihood of receiving the same or similar configuration updates, and/or that should be grouped based on one or more other suitable factors. As discussed above, situations may arise in which one particular NF (or NF instance) is assigned to multiple NF groups. For example, the particular NF may share attributes with different sets of NFs, and may accordingly be assigned to multiple NF groups. As discussed above, in some embodiments, DMS 103 may indicate the assignment of one or more NF groups to the NFs of such NF groups. On the other hand, in some embodiments, DMS 103 may forgo providing such indication (e.g., NFs may be “unaware” of having been assigned to a respective NF group).

Process 1100 may additionally include receiving or determining (at 1106) an NF configuration update. The configuration update may include values, parameters, variables, etc. that, when applied by a given NF, modify parameters of operation of the NF. Such configuration update may have been determined for load balancing purposes, to improve the performance of one or more NFs, and/or to otherwise improve the efficiency or operation of the network.

Process 1100 may also include identifying (at 1108) a particular NF group to which the NF configuration update is applicable. For example, DMS 103 may identify that the NF configuration update is applicable to NFs of a particular geographical region, NFs that are implemented by a particular type of hardware, etc. Additionally, or alternatively, the NF configuration update may include an indication of specific NFs to which the NF configuration update is applicable.

Process 1100 may further include determining (at 1110) a routing path associated with the NF configuration update and/or with the identified particular NF group. For example, as discussed above, DMS 103 may identify a routing path such that NFs of the particular NF group are able to propagate the configuration update, without relying on a communication link between all of the NFs of the group and DMS 103. The routing path may be selected based on factors such as speed of propagation, geographical location, redundancy, and/or other suitable factors, as discussed above. The routing path may specify one or more sequences of NFs (e.g., a first NF should route the NF configuration update to a second NF, the second NF should route the NF configuration update to a third NF, and so on).

Process 1100 may additionally include outputting (at 1112), to a particular NF of the identified NF group, the NF configuration update and routing path information. For example, as discussed above, DMS 103 may select a configuration gateway NF based on one or more suitable factors, and may provide the NF configuration update to the configuration gateway NF. In some embodiments, DMS 103 may explicitly notify some or all of the NFs of the routing path (e.g., prior to providing the NF configuration update to one or more NFs of the group). Additionally, or alternatively, DMS 103 may include the routing path with the NF configuration update. As discussed above, the NFs of the NF group may propagate (at 1114) the configuration update in accordance with the routing path information (e.g., in a distributed manner). As discussed above, the NFs may further determine whether the NF configuration update is applicable to such NFs based on one or more policies maintained by the NFs, may cache the NF configuration update, and/or may perform other suitable operations with respect to the NF configuration update.

In this manner, NFs may communicate in a distributed manner in order to propagate NF configuration updates, without relying on centralized links between the NFs and a management or configuration platform. These techniques may also be employed in architectures in which NFs of a given group are not directly connected to all NFs of the same group (e.g., configuration updates may be routed via multiple NFs of such group in order to ultimately propagate the updates to all NFs of the group).

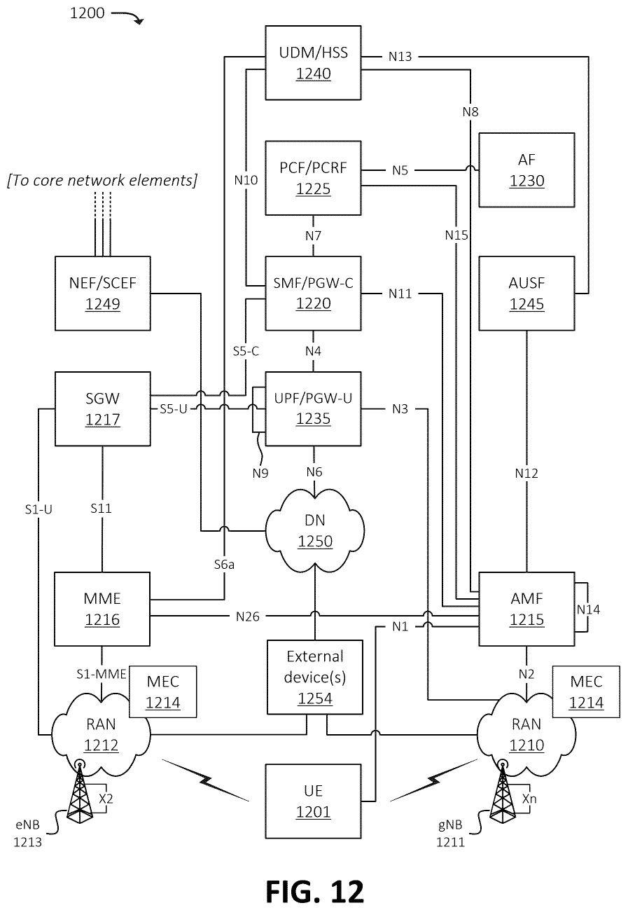

FIG. 12 illustrates an example environment 1200, in which one or more embodiments may be implemented. In some embodiments, environment 1200 may correspond to a Fifth Generation (“5G”) network, and/or may include elements of a 5G network. In some embodiments, environment 1200 may correspond to a 5G Non-Standalone (“NSA”) architecture, in which a 5G radio access technology (“RAT”) may be used in conjunction with one or more other RATs (e.g., a Long-Term Evolution (“LTE”) RAT), and/or in which elements of a 5G core network may be implemented by, may be communicatively coupled with, and/or may include elements of another type of core network (e.g., an evolved packet core (“EPC”)). In some embodiments, portions of environment 1200 may represent or may include a 5G core (“5GC”). As shown, environment 1200 may include UE 1201, RAN 1210 (which may include one or more Next Generation Node Bs (“gNBs”) 1211), RAN 1212 (which may include one or more evolved Node Bs (“eNBs”) 1213), and various network functions such as AMF 1215, MME 1216, Serving Gateway (“SGW”) 1217, Session Management Function (“SMF”)/Packet Data Network (“PDN”) Gateway (“PGW”)-Control plane function (“PGW-C”) 1220, Policy Control Function (“PCF”)/Policy Charging and Rules Function (“PCRF”) 1225, Application Function (“AF”) 1230, User Plane Function (“UPF”)/PGW-User plane function (“PGW-U”) 1235, Unified Data Management (“UDM”)/Home Subscriber Server (“HSS”) 1240, Authentication Server Function (“AUSF”) 1245, and Network Exposure Function (“NEF”)/Service Capability Exposure Function (“SCEF”) 1249. Environment 1200 may also include one or more networks, such as Data Network (“DN”) 1250. Environment 1200 may include one or more additional devices or systems communicatively coupled to one or more networks (e.g., DN 1250), such as one or more external devices 1254.

The example shown in FIG. 12 illustrates one instance of each network component or function (e.g., one instance of SMF/PGW-C 1220, PCF/PCRF 1225, UPF/PGW-U 1235, UDM/HSS 1240, and/or AUSF 1245). In practice, environment 1200 may include multiple instances of such components or functions. For example, in some embodiments, environment 1200 may include multiple “slices” of a core network, where each slice includes a discrete and/or logical set of network functions (e.g., one slice may include a first instance of AMF 1215, SMF/PGW-C 1220, PCF/PCRF 1225, and/or UPF/PGW-U 1235, while another slice may include a second instance of AMF 1215, SMF/PGW-C 1220, PCF/PCRF 1225, and/or UPF/PGW-U 1235). The different slices may provide differentiated levels of service, such as service in accordance with different QoS parameters.

The quantity of devices and/or networks, illustrated in FIG. 12, is provided for explanatory purposes only. In practice, environment 1200 may include additional devices and/or networks, fewer devices and/or networks, different devices and/or networks, or differently arranged devices and/or networks than illustrated in FIG. 12. For example, while not shown, environment 1200 may include devices that facilitate or enable communication between various components shown in environment 1200, such as routers, modems, gateways, switches, hubs, etc. In some implementations, one or more devices of environment 1200 may be physically integrated in, and/or may be physically attached to, one or more other devices of environment 1200. Alternatively, or additionally, one or more of the devices of environment 1200 may perform one or more network functions described as being performed by another one or more of the devices of environment 1200.

Additionally, one or more elements of environment 1200 may be implemented in a virtualized and/or containerized manner. For example, one or more of the elements of environment 1200 may be implemented by one or more Virtualized Network Functions (“VNFs”), Cloud-Native Network Functions (“CNFs”), etc. In such embodiments, environment 1200 may include, may implement, and/or may be communicatively coupled to an orchestration platform that provisions hardware resources, installs containers or applications, performs load balancing, and/or otherwise manages the deployment of such elements of environment 1200. In some embodiments, such orchestration and/or management of such elements of environment 1200 may be performed by, or in conjunction with, the open-source Kubernetes® application programming interface (“API”) or some other suitable virtualization, containerization, and/or orchestration system.

Elements of environment 1200 may interconnect with each other and/or other devices via wired connections, wireless connections, or a combination of wired and wireless connections. Examples of interfaces or communication pathways between the elements of environment 1200, as shown in FIG. 12, may include an N1 interface, an N2 interface, an N3 interface, an N4 interface, an N5 interface, an N6 interface, an N7 interface, an N8 interface, an N9 interface, an N10 interface, an N11 interface, an N12 interface, an N13 interface, an N14 interface, an N15 interface, an N26 interface, an S1-C interface, an S1-U interface, an S5-C interface, an S5-U interface, an S6a interface, an S11 interface, and/or one or more other interfaces. Such interfaces may include interfaces not explicitly shown in FIG. 12, such as Service-Based Interfaces (“SBIs”), including an Namf interface, an Nudm interface, an Npcf interface, an Nupf interface, an Nnef interface, an Nsmf interface, and/or one or more other SBIs.

UE 1201 may include a computation and communication device, such as a wireless mobile communication device that is capable of communicating with RAN 1210, RAN 1212, and/or DN 1250. UE 1201 may be, or may include, a radiotelephone, a personal communications system (“PCS”) terminal (e.g., a device that combines a cellular radiotelephone with data processing and data communications capabilities), a personal digital assistant (“PDA”) (e.g., a device that may include a radiotelephone, a pager, Internet/intranet access, etc.), a smart phone, a laptop computer, a tablet computer, a camera, a personal gaming system, an Internet of Things (“IoT”) device (e.g., a sensor, a smart home appliance, a wearable device, a programmable logic controller or other industrial controller, a Machine-to-Machine (“M2M”) device, or the like), a Fixed Wireless Access (“FWA”) device, or another type of mobile computation and communication device. UE 1201 may send traffic to and/or receive traffic (e.g., user plane traffic) from DN 1250 via RAN 1210, RAN 1212, and/or UPF/PGW-U 1235.

RAN 1210 may be, or may include, a 5G RAN that implements a 5G RAT and that includes one or more base stations (e.g., one or more gNBs 1211), via which UE 1201 may communicate with one or more other elements of environment 1200. UE 1201 may communicate with RAN 1210 via an air interface (e.g., as provided by gNB 1211). For instance, RAN 1210 may receive traffic (e.g., user plane traffic such as voice call traffic, data traffic, messaging traffic, etc.) from UE 1201 via the air interface, and may communicate the traffic to UPF/PGW-U 1235 and/or one or more other devices or networks. Further, RAN 1210 may receive signaling traffic, control plane traffic, etc. from UE 1201 via the air interface, and may communicate such signaling traffic, control plane traffic, etc. to AMF 1215 and/or one or more other devices or networks. Additionally, RAN 1210 may receive traffic intended for UE 1201 (e.g., from UPF/PGW-U 1235, AMF 1215, and/or one or more other devices or networks) and may communicate the traffic to UE 1201 via the air interface.

RAN 1212 may be, or may include, an LTE RAN that implements an LTE RAT and that includes one or more base stations (e.g., one or more eNBs 1213), via which UE 1201 may communicate with one or more other elements of environment 1200. UE 1201 may communicate with RAN 1212 via an air interface (e.g., as provided by eNB 1213). For instance, RAN 1212 may receive traffic (e.g., user plane traffic such as voice call traffic, data traffic, messaging traffic, signaling traffic, etc.) from UE 1201 via the air interface, and may communicate the traffic to UPF/PGW-U 1235 (e.g., via SGW 1217) and/or one or more other devices or networks. Further, RAN 1212 may receive signaling traffic, control plane traffic, etc. from UE 1201 via the air interface, and may communicate such signaling traffic, control plane traffic, etc. to MME 1216 and/or one or more other devices or networks. Additionally, RAN 1212 may receive traffic intended for UE 1201 (e.g., from UPF/PGW-U 1235, MME 1216, SGW 1217, and/or one or more other devices or networks) and may communicate the traffic to UE 1201 via the air interface.

One or more RANs of environment 1200 (e.g., RAN 1210 and/or RAN 1212) may include, may implement, and/or may otherwise be communicatively coupled to one or more edge computing devices, such as one or more Multi-Access/Mobile Edge Computing (“MEC”) devices (referred to sometimes herein simply as a “MECs”) 1214. MECs 1214 may be co-located with wireless network infrastructure equipment of RANs 1210 and/or 1212 (e.g., one or more gNBs 1211 and/or one or more eNBs 1213, respectively). Additionally, or alternatively, MECs 1214 may otherwise be associated with geographical regions (e.g., coverage areas) of wireless network infrastructure equipment of RANs 1210 and/or 1212. In some embodiments, one or more MECs 1214 may be implemented by the same set of hardware resources, the same set of devices, etc. that implement wireless network infrastructure equipment of RANs 1210 and/or 1212. In some embodiments, one or more MECs 1214 may be implemented by different hardware resources, a different set of devices, etc. from hardware resources or devices that implement wireless network infrastructure equipment of RANs 1210 and/or 1212. In some embodiments, MECs 1214 may be communicatively coupled to wireless network infrastructure equipment of RANs 1210 and/or 1212 (e.g., via a high-speed and/or low-latency link such as a physical wired interface, a high-speed and/or low-latency wireless interface, or some other suitable communication pathway).

MECs 1214 may include hardware resources (e.g., configurable or provisionable hardware resources) that may be configured to provide services and/or otherwise process traffic to and/or from UE 1201, via RAN 1210 and/or 1212. For example, RAN 1210 and/or 1212 may route some traffic from UE 1201 (e.g., traffic associated with one or more particular services, applications, application types, etc.) to a respective MEC 1214 instead of to core network elements of 1200 (e.g., UPF/PGW-U 1235). MEC 1214 may accordingly provide services to UE 1201 by processing such traffic, performing one or more computations based on the received traffic, and providing traffic to UE 1201 via RAN 1210 and/or 1212. MEC 1214 may include, and/or may implement, some or all of the functionality described above with respect to UPF/PGW-U 1235, AF 1230, one or more application servers, and/or one or more other devices, systems, VNFs, CNFs, etc. In this manner, ultra-low latency services may be provided to UE 1201, as traffic does not need to traverse links (e.g., backhaul links) between RAN 1210 and/or 1212 and the core network.

AMF 1215 may include one or more devices, systems, VNFs, CNFs, etc., that perform operations to register UE 1201 with the 5G network, to establish bearer channels associated with a session with UE 1201, to hand off UE 1201 from the 5G network to another network, to hand off UE 1201 from the other network to the 5G network, manage mobility of UE 1201 between RANs 1210 and/or gNBs 1211, and/or to perform other operations. In some embodiments, the 5G network may include multiple AMFs 1215, which communicate with each other via the N14 interface (denoted in FIG. 12 by the line marked “N14” originating and terminating at AMF 1215).

MME 1216 may include one or more devices, systems, VNFs, CNFs, etc., that perform operations to register UE 1201 with the EPC, to establish bearer channels associated with a session with UE 1201, to hand off UE 1201 from the EPC to another network, to hand off UE 1201 from another network to the EPC, manage mobility of UE 1201 between RANs 1212 and/or eNBs 1213, and/or to perform other operations.

SGW 1217 may include one or more devices, systems, VNFs, CNFs, etc., that aggregate traffic received from one or more eNBs 1213 and send the aggregated traffic to an external network or device via UPF/PGW-U 1235. Additionally, SGW 1217 may aggregate traffic received from one or more UPF/PGW-Us 1235 and may send the aggregated traffic to one or more eNBs 1213. SGW 1217 may operate as an anchor for the user plane during inter-eNB handovers and as an anchor for mobility between different telecommunication networks or RANs (e.g., RANs 1210 and 1212).

SMF/PGW-C 1220 may include one or more devices, systems, VNFs, CNFs, etc., that gather, process, store, and/or provide information in a manner described herein. SMF/PGW-C 1220 may, for example, facilitate the establishment of communication sessions on behalf of UE 1201. In some embodiments, the establishment of communications sessions may be performed in accordance with one or more policies provided by PCF/PCRF 1225.

PCF/PCRF 1225 may include one or more devices, systems, VNFs, CNFs, etc., that aggregate information to and from the 5G network and/or other sources. PCF/PCRF 1225 may receive information regarding policies and/or subscriptions from one or more sources, such as subscriber databases and/or from one or more users (such as, for example, an administrator associated with PCF/PCRF 1225).

AF 1230 may include one or more devices, systems, VNFs, CNFs, etc., that receive, store, and/or provide information that may be used in determining parameters (e.g., quality of service parameters, charging parameters, or the like) for certain applications.

UPF/PGW-U 1235 may include one or more devices, systems, VNFs, CNFs, etc., that receive, store, and/or provide data (e.g., user plane data). For example, UPF/PGW-U 1235 may receive user plane data (e.g., voice call traffic, data traffic, etc.), destined for UE 1201, from DN 1250, and may forward the user plane data toward UE 1201 (e.g., via RAN 1210, SMF/PGW-C 1220, and/or one or more other devices). In some embodiments, multiple instances of UPF/PGW-U 1235 may be deployed (e.g., in different geographical locations), and the delivery of content to UE 1201 may be coordinated via the N9 interface (e.g., as denoted in FIG. 12 by the line marked “N9” originating and terminating at UPF/PGW-U 1235). Similarly, UPF/PGW-U 1235 may receive traffic from UE 1201 (e.g., via RAN 1210, RAN 1212, SMF/PGW-C 1220, and/or one or more other devices), and may forward the traffic toward DN 1250. In some embodiments, UPF/PGW-U 1235 may communicate (e.g., via the N4 interface) with SMF/PGW-C 1220, regarding user plane data processed by UPF/PGW-U 1235.

UDM/HSS 1240 and AUSF 1245 may include one or more devices, systems, VNFs, CNFs, etc., that manage, update, and/or store, in one or more memory devices associated with AUSF 1245 and/or UDM/HSS 1240, profile information associated with a subscriber. In some embodiments, UDM/HSS 1240 may include, may implement, may be communicatively coupled to, and/or may otherwise be associated with some other type of repository or database, such as a Unified Data Repository (“UDR”). AUSF 1245 and/or UDM/HSS 1240 may perform authentication, authorization, and/or accounting operations associated with one or more UEs 1201 and/or one or more communication sessions associated with one or more UEs 1201.

DN 1250 may include one or more wired and/or wireless networks. For example, DN 1250 may include an Internet Protocol (“IP”)-based PDN, a wide area network (“WAN”) such as the Internet, a private enterprise network, and/or one or more other networks. UE 1201 may communicate, through DN 1250, with data servers, other UEs 1201, and/or to other servers or applications that are coupled to DN 1250. DN 1250 may be connected to one or more other networks, such as a public switched telephone network (“PSTN”), a public land mobile network (“PLMN”), and/or another network. DN 1250 may be connected to one or more devices, such as content providers, applications, web servers, and/or other devices, with which UE 1201 may communicate.

External devices 1254 may include one or more devices or systems that communicate with UE 1201 via DN 1250 and one or more elements of 1200 (e.g., via UPF/PGW-U 1235). In some embodiments, external devices 1254 may include, may implement, and/or may otherwise be associated with DMS 103. External devices 1254 may include, for example, one or more application servers, content provider systems, web servers, or the like. External devices 1254 may, for example, implement “server-side” applications that communicate with “client-side” applications executed by UE 1201. External devices 1254 may provide services to UE 1201 such as gaming services, videoconferencing services, messaging services, email services, web services, and/or other types of services.

In some embodiments, external devices 1254 may communicate with one or more elements of environment 1200 (e.g., core network elements) via NEF/SCEF 1249. NEF/SCEF 1249 include one or more devices, systems, VNFs, CNFs, etc. that provide access to information, APIs, and/or other operations or mechanisms of one or more core network elements to devices or systems that are external to the core network (e.g., to external device 1254 via DN 1250). NEF/SCEF 1249 may maintain authorization and/or authentication information associated with such external devices or systems, such that NEF/SCEF 1249 is able to provide information, that is authorized to be provided, to the external devices or systems. For example, a given external device 1254 may request particular information associated with one or more core network elements. NEF/SCEF 1249 may authenticate the request and/or otherwise verify that external device 1254 is authorized to receive the information, and may request, obtain, or otherwise receive the information from the one or more core network elements. In some embodiments, NEF/SCEF 1249 may include, may implement, may be implemented by, may be communicatively coupled to, and/or may otherwise be associated with a Security Edge Protection Proxy (“SEPP”), which may perform some or all of the functions discussed above. External device 1254 may, in some situations, subscribe to particular types of requested information provided by the one or more core network elements, and the one or more core network elements may provide (e.g., “push”) the requested information to NEF/SCEF 1249 (e.g., in a periodic or otherwise ongoing basis).

In some embodiments, external devices 1254 may communicate with one or more elements of RAN 1210 and/or 1212 via an API or other suitable interface. For example, a given external device 1254 may provide instructions, requests, etc. to RAN 1210 and/or 1212 to provide one or more services via one or more respective MECs 1214. In some embodiments, such instructions, requests, etc. may include QoS parameters, Service Level Agreements (“SLAs”), etc. (e.g., maximum latency thresholds, minimum throughput thresholds, etc.) associated with the services.

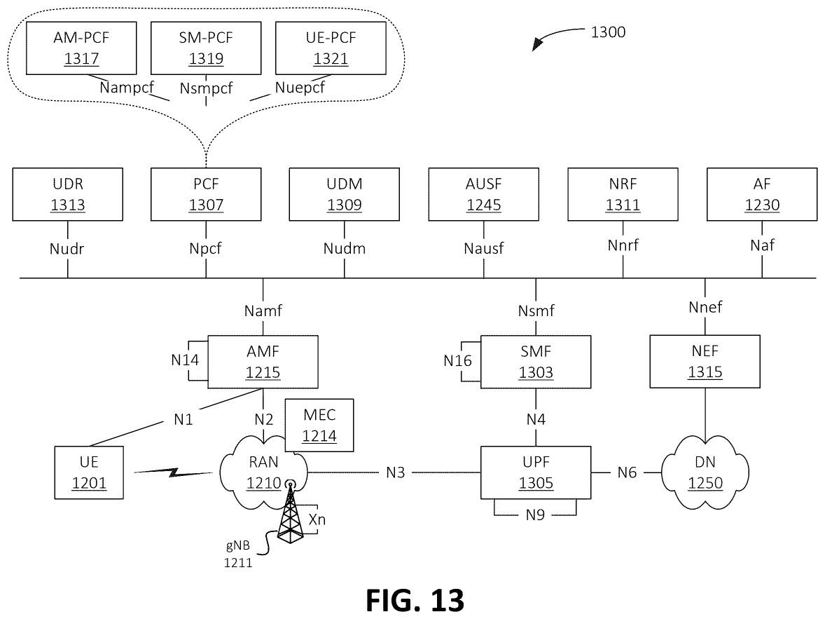

FIG. 13 illustrates another example environment 1300, in which one or more embodiments may be implemented. In some embodiments, environment 1300 may correspond to a 5G network, and/or may include elements of a 5G network. In some embodiments, environment 1300 may correspond to a 5G SA architecture. In some embodiments, environment 1300 may include a 5GC, in which 5GC network elements perform one or more operations described herein.

As shown, environment 1300 may include UE 1201, RAN 1210 (which may include one or more gNBs 1211 or other types of wireless network infrastructure) and various network functions, which may be implemented as VNFs, CNFs, etc. Such network functions may include AMF 1215, SMF 1303, UPF 1305, PCF 1307, UDM 1309, AUSF 1245, Network Repository Function (“NRF”) 1311, AF 1230, UDR 1313, and NEF 1315. Environment 1300 may also include or may be communicatively coupled to one or more networks, such as DN 1250.

The example shown in FIG. 13 illustrates one instance of each network component or function (e.g., one instance of SMF 1303, UPF 1305, PCF 1307, UDM 1309, AUSF 1245, etc.). In practice, environment 1300 may include multiple instances of such components or functions. For example, in some embodiments, environment 1300 may include multiple “slices” of a core network, where each slice includes a discrete and/or logical set of network functions (e.g., one slice may include a first instance of SMF 1303, PCF 1307, UPF 1305, etc., while another slice may include a second instance of SMF 1303, PCF 1307, UPF 1305, etc.). Additionally, or alternatively, one or more of the network functions of environment 1300 may implement multiple network slices. The different slices may provide differentiated levels of service, such as service in accordance with different QoS parameters.

The quantity of devices and/or networks, illustrated in FIG. 13, is provided for explanatory purposes only. In practice, environment 1300 may include additional devices and/or networks, fewer devices and/or networks, different devices and/or networks, or differently arranged devices and/or networks than illustrated in FIG. 13. For example, while not shown, environment 1300 may include devices that facilitate or enable communication between various components shown in environment 1300, such as routers, modems, gateways, switches, hubs, etc. In some implementations, one or more devices of environment 1300 may be physically integrated in, and/or may be physically attached to, one or more other devices of environment 1300. Alternatively, or additionally, one or more of the devices of environment 1300 may perform one or more network functions described as being performed by another one or more of the devices of environment 1300.

Elements of environment 1300 may interconnect with each other and/or other devices via wired connections, wireless connections, or a combination of wired and wireless connections. Examples of interfaces or communication pathways between the elements of environment 1300, as shown in FIG. 13, may include interfaces shown in FIG. 13 and/or one or more interfaces not explicitly shown in FIG. 13. These interfaces may include interfaces between specific network functions, such as an N1 interface, an N2 interface, an N3 interface, an N6 interface, an N9 interface, an N14 interface, an N16 interface, and/or one or more other interfaces. In some embodiments, one or more elements of environment 1300 may communicate via a service-based architecture (“SBA”), in which a routing mesh or other suitable routing mechanism may route communications to particular network functions based on interfaces or identifiers associated with such network functions. Such interfaces may include or may be referred to as SBIs, including an Namf interface (e.g., indicating communications to be routed to AMF 1215), an Nudm interface (e.g., indicating communications to be routed to UDM 1309), an Npcf interface, an Nupf interface, an Nnef interface, an Nsmf interface, an Nnrf interface, an Nudr interface, an Naf interface, and/or one or more other SBIs.

UPF 1305 may include one or more devices, systems, VNFs, CNFs, etc., that receive, route, process, and/or forward traffic (e.g., user plane traffic). As discussed above, UPF 1305 may communicate with UE 1201 via one or more communication sessions, such as PDU sessions. Such PDU sessions may be associated with a particular network slice or other suitable QoS parameters, as noted above. UPF 1305 may receive downlink user plane traffic (e.g., voice call traffic, data traffic, etc. destined for UE 1201) from DN 1250, and may forward the downlink user plane traffic toward UE 1201 (e.g., via RAN 1210). In some embodiments, multiple UPFs 1305 may be deployed (e.g., in different geographical locations), and the delivery of content to UE 1201 may be coordinated via the N9 interface. Similarly, UPF 1305 may receive uplink traffic from UE 1201 (e.g., via RAN 1210), and may forward the traffic toward DN 1250. In some embodiments, UPF 1305 may implement, may be implemented by, may be communicatively coupled to, and/or may otherwise be associated with UPF/PGW-U 1235. In some embodiments, UPF 1305 may communicate (e.g., via the N4 interface) with SMF 1303, regarding user plane data processed by UPF 1305 (e.g., to provide analytics or reporting information, to receive policy and/or authorization information, etc.).

PCF 1307 may include one or more devices, systems, VNFs, CNFs, etc., that aggregate, derive, generate, etc. policy information associated with the 5GC and/or UEs 1201 that communicate via the 5GC and/or RAN 1210. PCF 1307 may receive information regarding policies and/or subscriptions from one or more sources, such as subscriber databases (e.g., UDM 1309, UDR 1313, etc.), and/or from one or more users such as, for example, an administrator associated with PCF 1307. In some embodiments, the functionality of PCF 1307 may be split into multiple network functions or subsystems, such as access and mobility PCF (“AM-PCF”) 1317, session management PCF (“SM-PCF”) 1319, UE PCF (“UE-PCF”) 1321, and so on. Such different “split” PCFs may be associated with respective SBIs (e.g., AM-PCF 1317 may be associated with an Nampcf SBI, SM-PCF 1319 may be associated with an Nsmpcf SBI, UE-PCF 1321 may be associated with an Nuepcf SBI, and so on) via which other network functions may communicate with the split PCFs. The split PCFs may maintain information regarding policies associated with different devices, systems, and/or network functions.

NRF 1311 may include one or more devices, systems, VNFs, CNFs, etc. that maintain routing and/or network topology information associated with the 5GC. For example, NRF 1311 may maintain and/or provide IP addresses of one or more network functions, routes associated with one or more network functions, discovery and/or mapping information associated with particular network functions or network function instances (e.g., whereby such discovery and/or mapping information may facilitate the SBA), and/or other suitable information.

UDR 1313 may include one or more devices, systems, VNFs, CNFs, etc. that provide user and/or subscriber information, based on which PCF 1307 and/or other elements of environment 1300 may determine access policies, QoS policies, charging policies, or the like. In some embodiments, UDR 1313 may receive such information from UDM 1309 and/or one or more other sources.

NEF 1315 include one or more devices, systems, VNFs, CNFs, etc. that provide access to information, APIs, and/or other operations or mechanisms of the 5GC to devices or systems that are external to the 5GC. NEF 1315 may maintain authorization and/or authentication information associated with such external devices or systems, such that NEF 1315 is able to provide information, that is authorized to be provided, to the external devices or systems. Such information may be received from other network functions of the 5GC (e.g., as authorized by an administrator or other suitable entity associated with the 5GC), such as SMF 1303, UPF 1305, a charging function (“CHF”) of the 5GC, and/or other suitable network function. NEF 1315 may communicate with external devices or systems (e.g., external devices 1254) via DN 1250 and/or other suitable communication pathways.

While environment 1300 is described in the context of a 5GC, as noted above, environment 1300 may, in some embodiments, include or implement one or more other types of core networks. For example, in some embodiments, environment 1300 may be or may include a converged packet core, in which one or more elements may perform some or all of the functionality of one or more 5GC network functions and/or one or more EPC network functions. For example, in some embodiments, AMF 1215 may include, may implement, may be implemented by, and/or may otherwise be associated with MME 1216; SMF 1303 may include, may implement, may be implemented by, and/or may otherwise be associated with SGW 1217; PCF 1307 may include, may implement, may be implemented by, and/or may otherwise be associated with a PCRF (e.g., PCF/PCRF 1225); NEF 1315 may include, may implement, may be implemented by, and/or may otherwise be associated with a SCEF (e.g., NEF/SCEF 1249); and so on.

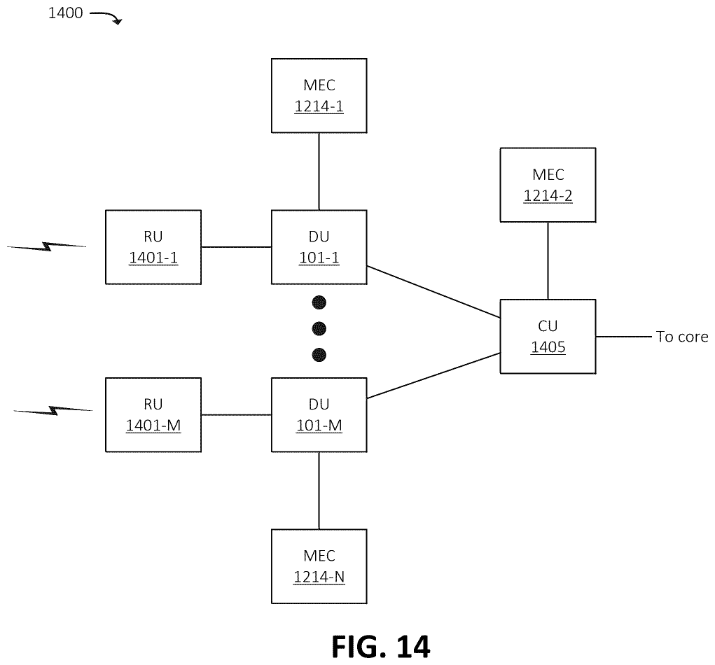

FIG. 14 illustrates an example RAN environment 1400, which may be included in and/or implemented by one or more RANs (e.g., RAN 1210 or some other RAN). In some embodiments, a particular RAN 1210 may include one RAN environment 1400. In some embodiments, a particular RAN 1210 may include multiple RAN environments 1400. In some embodiments, RAN environment 1400 may correspond to a particular gNB 1211 of RAN 1210. In some embodiments, RAN environment 1400 may correspond to multiple gNBs 1211. In some embodiments, RAN environment 1400 may correspond to one or more other types of base stations of one or more other types of RANs. As shown, RAN environment 1400 may include CU 1405, one or more DUs 101-1 through 101-M (referred to individually as “DU 101,” or collectively as “DUs 101”), and one or more RUs 1401-1 through 1401-M (referred to individually as “RU 1401,” or collectively as “RUs 1401”).

CU 1405 may communicate with a core of a wireless network (e.g., may communicate with one or more of the devices or systems described above with respect to FIG. 13, such as AMF 1215 and/or UPF 1305) and/or some other device or system such as MEC 1214. In the uplink direction (e.g., for traffic from UEs 1201 to a core network), CU 1405 may aggregate traffic from DUs 101, and forward the aggregated traffic to the core network. In some embodiments, CU 1405 may receive traffic according to a given protocol (e.g., Radio Link Control (“RLC”) traffic) from DUs 101, and may perform higher-layer processing (e.g., may aggregate/process RLC packets and generate Packet Data Convergence Protocol (“PDCP”) packets based on the RLC packets) on the traffic received from DUs 101.

CU 1405 may receive downlink traffic (e.g., traffic from the core network, traffic from a given MEC 1214, etc.) for a particular UE 1201, and may determine which DU(s) 101 should receive the downlink traffic. DU 101 may include one or more devices that transmit traffic between a core network (e.g., via CU 1405) and UE 1201 (e.g., via a respective RU 1401). DU 101 may, for example, receive traffic from RU 1401 at a first layer (e.g., physical (“PHY”) layer traffic, or lower PHY layer traffic), and may process/aggregate the traffic to a second layer (e.g., upper PHY and/or RLC). DU 101 may receive traffic from CU 1405 at the second layer, may process the traffic to the first layer, and provide the processed traffic to a respective RU 1401 for transmission to UE 1201.

RU 1401 may include hardware circuitry (e.g., one or more RF transceivers, antennas, radios, and/or other suitable hardware) to communicate wirelessly (e.g., via an RF interface) with one or more UEs 1201, one or more other DUs 101 (e.g., via RUs 1401 associated with DUs 101), and/or any other suitable type of device. In the uplink direction, RU 1401 may receive traffic from UE 1201 and/or another DU 101 via the RF interface and may provide the traffic to DU 101. In the downlink direction, RU 1401 may receive traffic from DU 101, and may provide the traffic to UE 1201 and/or another DU 101.

One or more elements of RAN environment 1400 may, in some embodiments, be communicatively coupled to one or more MECs 1214. For example, DU 101-1 may be communicatively coupled to MEC 1214-1, DU 101-M may be communicatively coupled to MEC 1214-N, CU 1405 may be communicatively coupled to MEC 1214-2, and so on. MECs 1214 may include hardware resources (e.g., configurable or provisionable hardware resources) that may be configured to provide services and/or otherwise process traffic to and/or from UE 1201, via a respective RU 1401.

For example, DU 101-1 may route some traffic, from UE 1201, to MEC 1214-1 instead of to a core network via CU 1405. MEC 1214-1 may process the traffic, perform one or more computations based on the received traffic, and may provide traffic to UE 1201 via RU 1401-1. As discussed above, MEC 1214 may include, and/or may implement, some or all of the functionality described above with respect to UPF 1305, AF 1230, and/or one or more other devices, systems, VNFs, CNFs, etc. In this manner, ultra-low latency services may be provided to UE 1201, as traffic does not need to traverse DU 101, CU 1405, links between DU 101 and CU 1405, and an intervening backhaul network between RAN environment 1400 and the core network.

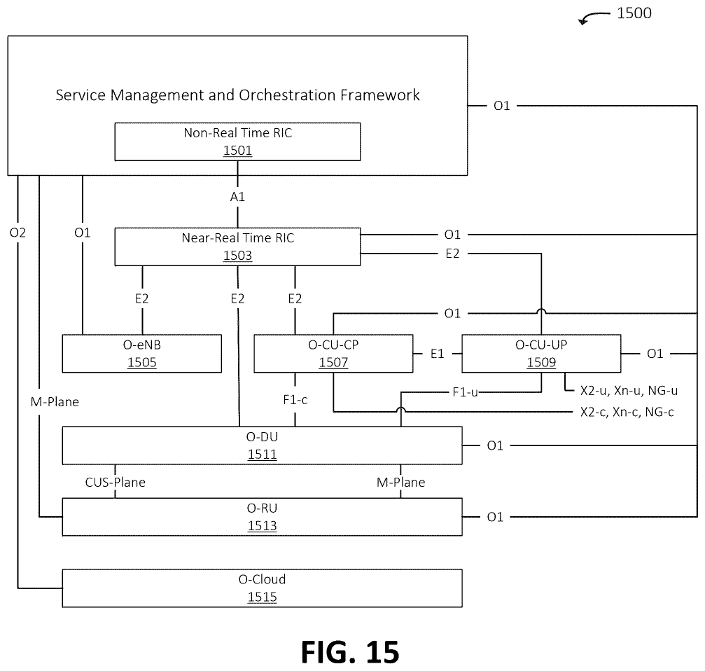

FIG. 15 illustrates an example O-RAN environment 1500, which may correspond to RAN 1210, RAN 1212, and/or RAN environment 1400. For example, RAN 1210, RAN 1212, and/or RAN environment 1400 may include one or more instances of O-RAN environment 1500, and/or one or more instances of O-RAN environment 1500 may implement RAN 1210, RAN 1212, RAN environment 1400, and/or some portion thereof. As shown, O-RAN environment 1500 may include Non-Real Time Radio Intelligent Controller (“RIC”) 1501, Near-Real Time RIC 1503, O-eNB 1505, O-CU-Control Plane (“O-CU-CP”) 1507, O-CU-User Plane (“O-CU-UP”) 1509, O-DU 1511, O-RU 1513, and O-Cloud 1515. In some embodiments, O-RAN environment 1500 may include additional, fewer, different, and/or differently arranged components or interfaces.

In some embodiments, some or all of the elements of O-RAN environment 1500 may be implemented by one or more configurable or provisionable resources, such as virtual machines, cloud computing systems, physical servers, and/or other types of configurable or provisionable resources. In some embodiments, some or all of O-RAN environment 1500 may be implemented by, and/or communicatively coupled to, one or more MECs 1214.

Non-Real Time RIC 1501 and Near-Real Time RIC 1503 may receive performance information (and/or other types of information) from one or more sources, and may configure other elements of O-RAN environment 1500 based on such performance or other information. For example, Near-Real Time RIC 1503 may receive performance information, via one or more E2 interfaces, from O-eNB 1505, O-CU-CP 1507, and/or O-CU-UP 1509, and may modify parameters associated with O-eNB 1505, O-CU-CP 1507, and/or O-CU-UP 1509 based on such performance information. Similarly, Non-Real Time RIC 1501 may receive performance information associated with O-eNB 1505, O-CU-CP 1507, O-CU-UP 1509, and/or one or more other elements of O-RAN environment 1500 and may utilize machine learning and/or other higher level computing or processing to determine modifications to the configuration of O-eNB 1505, O-CU-CP 1507, O-CU-UP 1509, and/or other elements of O-RAN environment 1500. In some embodiments, Non-Real Time RIC 1501 may generate machine learning models based on performance information associated with O-RAN environment 1500 or other sources, and may provide such models to Near-Real Time RIC 1503 for implementation.

In some embodiments, one or more operations described above with respect to DMS 103 may be performed by Non-Real Time RIC 1501 and/or Near-Real Time RIC 1503. In some embodiments, one or more operations described above with respect to Non-Real Time RIC 1501 and/or Near-Real Time RIC 1503 may be performed by DMS 103.

O-eNB 1505 may perform functions similar to those described above with respect to gNB 1211 and/or eNB 1213. For example, O-eNB 1505 may facilitate wireless communications between UE 1201 and a core network. O-CU-CP 1507 may perform control plane signaling to coordinate the aggregation and/or distribution of traffic via one or more DUs 101, which may include and/or be implemented by one or more O-DUs 1511, and O-CU-UP 1509 may perform the aggregation and/or distribution of traffic via such DUs 101 (e.g., O-DUs 1511). O-DU 1511 may be communicatively coupled to one or more RUs 1401, which may include and/or may be implemented by one or more O-RUs 1513. In some embodiments, O-Cloud 1515 may include or be implemented by one or more MECs 1214, which may provide services, and may be communicatively coupled, to O-CU-CP 1507, O-CU-UP 1509, O-DU 1511, and/or O-RU 1513 (e.g., via an O1 and/or O2 interface).

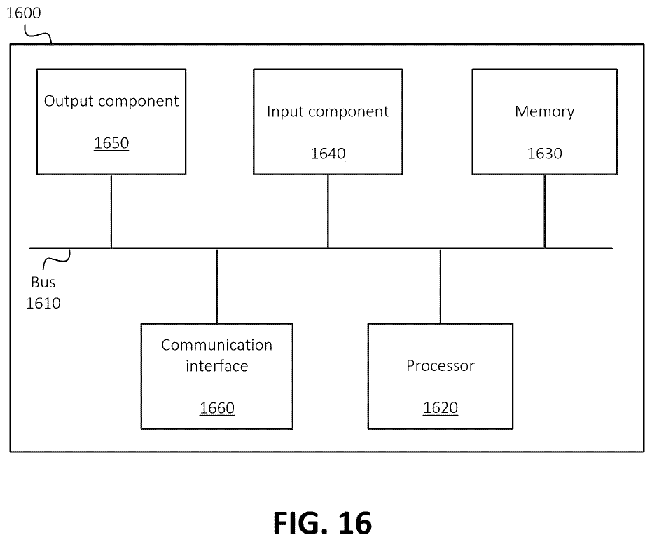

FIG. 16 illustrates example components of device 1600. One or more of the devices described above may include one or more devices 1600. Device 1600 may include bus 1610, processor 1620, memory 1630, input component 1640, output component 1650, and communication interface 1660. In another implementation, device 1600 may include additional, fewer, different, or differently arranged components.

Bus 1610 may include one or more communication paths that permit communication among the components of device 1600. Processor 1620 may include a processor, microprocessor, a set of provisioned hardware resources of a cloud computing system, or other suitable type of hardware that interprets and/or executes instructions (e.g., processor-executable instructions). In some embodiments, processor 1620 may be or may include one or more hardware processors. Memory 1630 may include any type of dynamic storage device that may store information and instructions for execution by processor 1620, and/or any type of non-volatile storage device that may store information for use by processor 1620.

Input component 1640 may include a mechanism that permits an operator to input information to device 1600 and/or other receives or detects input from a source external to input component 1640, such as a touchpad, a touchscreen, a keyboard, a keypad, a button, a switch, a microphone or other audio input component, etc. In some embodiments, input component 1640 may include, or may be communicatively coupled to, one or more sensors, such as a motion sensor (e.g., which may be or may include a gyroscope, accelerometer, or the like), a location sensor (e.g., a Global Positioning System (“GPS”)-based location sensor or some other suitable type of location sensor or location determination component), a thermometer, a barometer, and/or some other type of sensor. Output component 1650 may include a mechanism that outputs information to the operator, such as a display, a speaker, one or more light emitting diodes (“LEDs”), etc.

Communication interface 1660 may include any transceiver-like mechanism that enables device 1600 to communicate with other devices and/or systems (e.g., via RAN 1210, RAN 1212, DN 1250, etc.). For example, communication interface 1660 may include an Ethernet interface, an optical interface, a coaxial interface, or the like. Communication interface 1660 may include a wireless communication device, such as an infrared (“IR”) receiver, a Bluetooth® radio, or the like. The wireless communication device may be coupled to an external device, such as a cellular radio, a remote control, a wireless keyboard, a mobile telephone, etc. In some embodiments, device 1600 may include more than one communication interface 1660. For instance, device 1600 may include an optical interface, a wireless interface, an Ethernet interface, and/or one or more other interfaces.

Device 1600 may perform certain operations relating to one or more processes described above. Device 1600 may perform these operations in response to processor 1620 executing instructions, such as software instructions, processor-executable instructions, etc. stored in a computer-readable medium, such as memory 1630. A computer-readable medium may be defined as a non-transitory memory device. A memory device may include space within a single physical memory device or spread across multiple physical memory devices. The instructions may be read into memory 1630 from another computer-readable medium or from another device. The instructions stored in memory 1630 may be processor-executable instructions that cause processor 1620 to perform processes described herein. Alternatively, hardwired circuitry may be used in place of or in combination with software instructions to implement processes described herein. Thus, implementations described herein are not limited to any specific combination of hardware circuitry and software.

The foregoing description of implementations provides illustration and description, but is not intended to be exhaustive or to limit the possible implementations to the precise form disclosed. Modifications and variations are possible in light of the above disclosure or may be acquired from practice of the implementations.

For example, while series of blocks and/or signals have been described above (e.g., with regard to FIGS. 1-11), the order of the blocks and/or signals may be modified in other implementations. Further, non-dependent blocks and/or signals may be performed in parallel. Additionally, while the figures have been described in the context of particular devices performing particular acts, in practice, one or more other devices may perform some or all of these acts in lieu of, or in addition to, the above-mentioned devices.

The actual software code or specialized control hardware used to implement an embodiment is not limiting of the embodiment. Thus, the operation and behavior of the embodiment has been described without reference to the specific software code, it being understood that software and control hardware may be designed based on the description herein.

In the preceding specification, various example embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

Even though particular combinations of features are recited in the claims and/or disclosed in the specification, these combinations are not intended to limit the disclosure of the possible implementations. In fact, many of these features may be combined in ways not specifically recited in the claims and/or disclosed in the specification. Although each dependent claim listed below may directly depend on only one other claim, the disclosure of the possible implementations includes each dependent claim in combination with every other claim in the claim set.

Further, while certain connections or devices are shown, in practice, additional, fewer, or different, connections or devices may be used. Furthermore, while various devices and networks are shown separately, in practice, the functionality of multiple devices may be performed by a single device, or the functionality of one device may be performed by multiple devices. Further, multiple ones of the illustrated networks may be included in a single network, or a particular network may include multiple networks. Further, while some devices are shown as communicating with a network, some such devices may be incorporated, in whole or in part, as a part of the network.

To the extent the aforementioned implementations collect, store, or employ personal information of individuals, groups or other entities, it should be understood that such information shall be used in accordance with all applicable laws concerning protection of personal information. Additionally, the collection, storage, and use of such information can be subject to consent of the individual to such activity, for example, through well known “opt-in” or “opt-out” processes as can be appropriate for the situation and type of information. Storage and use of personal information can be in an appropriately secure manner reflective of the type of information, for example, through various access control, encryption and anonymization techniques for particularly sensitive information.

No element, act, or instruction used in the present application should be construed as critical or essential unless explicitly described as such. An instance of the use of the term “and,” as used herein, does not necessarily preclude the interpretation that the phrase “and/or” was intended in that instance. Similarly, an instance of the use of the term “or,” as used herein, does not necessarily preclude the interpretation that the phrase “and/or” was intended in that instance. Also, as used herein, the article “a” is intended to include one or more items, and may be used interchangeably with the phrase “one or more.” Where only one item is intended, the terms “one,” “single,” “only,” or similar language is used. Further, the phrase “based on” is intended to mean “based, at least in part, on” unless explicitly stated otherwise.

What is claimed is:

1. A device, comprising:
one or more processors configured to:
identify attributes of a plurality of network functions (“NFs”) of a wireless network;
determine, based on the attributes of the plurality of NFs, a plurality of NF groups, wherein a particular NF group, of the plurality of NF groups, includes a particular set of NFs out of the plurality of NFs;
receive or determine an NF configuration update;
determine that the NF configuration update is applicable to one or more NFs of the particular set of NFs;
identify a routing path associated with the particular set of NFs, wherein the routing path includes a sequence of NFs of the particular set of NFs; and
output, to a first NF of the particular set of NFs, the NF configuration update and information associated with the routing path, wherein the first NF identifies a second NF of the particular set of NFs based on the routing path and outputs the NF configuration update to the second NF based on the routing path.

2. The device of claim 1, wherein the plurality of NFs include a plurality of instances of a same particular type of NF.

3. The device of claim 2, wherein the plurality of instances of the same particular type of NF include a plurality of instances of a Distributed Unit (“DU”) of a radio access network (“RAN”) of the wireless network.

4. The device of claim 1, wherein the particular NF group is a first NF group, wherein the particular set of NFs is a first set of NFs, wherein the plurality of NF groups include a second NF group that includes a second set of NFs, wherein the attributes of the plurality of NFs include geographical information, and wherein determining the plurality of NF groups includes:
determining that the first set of NFs are associated with a first geographical region, and determining that the second set of NFs are associated with a second geographical region.

5. The device of claim 1, wherein the particular NF group is a first NF group, wherein the particular set of NFs is a first set of NFs, wherein the plurality of NF groups include a second NF group that includes a second set of NFs, and
wherein outputting the NF configuration update to the first NF of the first set of NFs includes forgoing outputting the NF configuration update to the second set of NFs of the second NF group.

6. The device of claim 1, wherein outputting the information associated with the routing path to the first NF is performed prior to outputting the configuration update to the first NF, wherein the first NF maintains the information associated with the routing path and uses the maintained information when receiving the configuration update.

7. The device of claim 1, wherein the first NF maintains a set of configuration update policies and selectively applies the received NF configuration update based on whether the set of configuration update policies are met.

8. A non-transitory computer-readable medium, storing a plurality of processor-executable instructions to:
identify attributes of a plurality of network functions (“NFs”) of a wireless network;
determine, based on the attributes of the plurality of NFs, a plurality of NF groups, wherein a particular NF group, of the plurality of NF groups, includes a particular set of NFs out of the plurality of NFs;
receive or determine an NF configuration update;
determine that the NF configuration update is applicable to one or more NFs of the particular set of NFs;
identify a routing path associated with the particular set of NFs, wherein the routing path includes a sequence of NFs of the particular set of NFs; and
output, to a first NF of the particular set of NFs, the NF configuration update and information associated with the routing path, wherein the first NF identifies a second NF of the particular set of NFs based on the routing path and outputs the NF configuration update to the second NF based on the routing path.

9. The non-transitory computer-readable medium of claim 8, wherein the plurality of NFs include a plurality of instances of a same particular type of NF.

10. The non-transitory computer-readable medium of claim 9, wherein the plurality of instances of the same particular type of NF include a plurality of instances of a Distributed Unit (“DU”) of a radio access network (“RAN”) of the wireless network.

11. The non-transitory computer-readable medium of claim 8, wherein the particular NF group is a first NF group, wherein the particular set of NFs is a first set of NFs, wherein the plurality of NF groups include a second NF group that includes a second set of NFs, wherein the attributes of the plurality of NFs include geographical information, and wherein determining the plurality of NF groups includes:
determining that the first set of NFs are associated with a first geographical region, and
determining that the second set of NFs are associated with a second geographical region.

12. The non-transitory computer-readable medium of claim 8, wherein the particular NF group is a first NF group, wherein the particular set of NFs is a first set of NFs, wherein the plurality of NF groups include a second NF group that includes a second set of NFs, and
wherein outputting the NF configuration update to the first NF of the first set of NFs includes forgoing outputting the NF configuration update to the second set of NFs of the second NF group.

13. The non-transitory computer-readable medium of claim 8, wherein outputting the information associated with the routing path to the first NF is performed prior to outputting the configuration update to the first NF, wherein the first NF maintains the information associated with the routing path and uses the maintained information when receiving the configuration update.

14. The non-transitory computer-readable medium of claim 8, wherein the first NF maintains a set of configuration update policies and selectively applies the received NF configuration update based on whether the set of configuration update policies are met.

15. A method, comprising:
identifying attributes of a plurality of network functions (“NFs”) of a wireless network;
determining, based on the attributes of the plurality of NFs, a plurality of NF groups, wherein a particular NF group, of the plurality of NF groups, includes a particular set of NFs out of the plurality of NFs;
receiving or determining an NF configuration update;
determining that the NF configuration update is applicable to one or more NFs of the particular set of NFs;
identifying a routing path associated with the particular set of NFs, wherein the routing path includes a sequence of NFs of the particular set of NFs; and
outputting, to a first NF of the particular set of NFs, the NF configuration update and information associated with the routing path, wherein the first NF identifies a second NF of the particular set of NFs based on the routing path and outputs the NF configuration update to the second NF based on the routing path.

16. The method of claim 15, wherein the plurality of NFs include a plurality of instances of a same particular type of NF.

17. The method of claim 15, wherein the particular NF group is a first NF group, wherein the particular set of NFs is a first set of NFs, wherein the plurality of NF groups include a second NF group that includes a second set of NFs, wherein the attributes of the plurality of NFs include geographical information, and wherein determining the plurality of NF groups includes:
determining that the first set of NFs are associated with a first geographical region, and
determining that the second set of NFs are associated with a second geographical region.

18. The method of claim 15, wherein the particular NF group is a first NF group, wherein the particular set of NFs is a first set of NFs, wherein the plurality of NF groups include a second NF group that includes a second set of NFs, and
wherein outputting the NF configuration update to the first NF of the first set of NFs includes forgoing outputting the NF configuration update to the second set of NFs of the second NF group.

19. The method of claim 15, wherein outputting the information associated with the routing path to the first NF is performed prior to outputting the configuration update to the first NF, wherein the first NF maintains the information associated with the routing path and uses the maintained information when receiving the configuration update.

20. The method of claim 15, wherein the first NF maintains a set of configuration update policies and selectively applies the received NF configuration update based on whether the set of configuration update policies are met.
